(19) United States
(12) Patent Application Publication
(10) Pub. No.: US 2025/0045000 A1
(43) Pub. Date: Feb. 6, 2025

(54) IMAGE FORMING APPARATUS CAPABLE OF MONITORING USE OF SUBSCRIPTION SERVICE, METHOD OF CONTROLLING IMAGE FORMING APPARATUS, AND STORAGE MEDIUM

(71) Applicant: CANON KABUSHIKI KAISHA, Tokyo (JP)

(72) Inventor: TAKUYA MATSUMURA, Tokyo (JP)

(21) Appl. No.: 18/785,326

(22) Filed: Jul. 26, 2024

(30) Foreign Application Priority Data
Aug. 4, 2023 (JP) 2023-128019

(51) Int. Cl. G06F 3/12

(52) U.S. Cl. CPC G06F 3/1222; G06F 3/1205; G06F 3/1207; G06F 3/1239; G06F 3/126; G06F 3/1273; G06F 3/1289

(57) ABSTRACT

An image forming apparatus capable of monitoring for unauthorized private use of a subscription service while taking privacy into consideration. The image forming apparatus executes a print job based on print data received from a communication apparatus. Whether or not the subscription service is used in the print job is determined. Control to provide logs of the print job to a contractor of the subscription service is performed. In a case where the print job is a print job using the subscription service, control to provide all logs of the print job to the contractor of the subscription service is performed, whereas in a case where the print job is a print job which does not use the subscription service, predetermined control to prevent leakage of information related to privacy from logs of the print job is performed.

### BACKGROUND OF THE INVENTION

### Field of the Invention

The present invention relates to an image forming apparatus that is capable of monitoring use of a subscription service, a method of controlling the image forming apparatus, and a storage medium.

### Description of the Related Art

There is known a subscription service that enables a user, who has made a contract with a company as a service provider, to use printing of a specific or smaller range of the number of prints and replacement of consumables, with a fixed charge, so long as it is within a contract period (see United States Patent Application No. US2021/0326083). Further, there is known a use form in which whether or not to use the subscription service is switched according to the purpose of use. For example, a user uses the subscription service contracted by his/her company in a case where the user prints a document of the company but does not use the subscription service in a case where the user performs private printing.

In the configuration in which whether or not to use the subscription service contracted by the company is switched according to the purpose of use as described above, it is possible to privately use the subscription. Therefore, it is necessary to monitor execution history of an image forming apparatus and inhibit unauthorized private use of the subscription service. As the method of monitoring the execution history, there can be mentioned, for example, a method of providing logs of print jobs executed by the image forming apparatus to a contractor of the subscription service. However, in the above-described configuration, logs of a private print job which does not use the subscription service are also provided to the contractor of the subscription service.

### SUMMARY OF THE INVENTION

The present invention provides a mechanism that makes it possible to monitor for unauthorized private use of a subscription service while taking privacy into consideration.

In a first aspect of the present invention, there is provided an image forming apparatus that executes a print job based on print data received from a communication apparatus, including at least one processor, and a memory coupled to the at least one processor storing instructions that, when executed by the processor, cause the processor to function as: a determination unit configured to determine whether or not a subscription service is used in the print job, and a control unit configured to perform control to provide logs of the print job to a contractor of the subscription service, wherein in a case where the print job is a print job using the subscription service, the control unit performs control to provide all logs of the print job to the contractor of the subscription service, whereas in a case where the print job is a print job which does not use the subscription service, the control unit performs predetermined control to prevent leakage of information related to privacy from logs of the print job.

In a second aspect of the present invention, there is provided a method of controlling an image forming apparatus that executes a print job based on print data received from a communication apparatus, including determining whether or not a subscription service is used in the print job, and performing control to provide logs of the print job to a contractor of the subscription service, and wherein the control includes control to provide all logs of the print job to the contractor of the subscription service in a case where the print job is a print job using the subscription service, and predetermined control to prevent leakage of information related to privacy from logs of the print job in a case where the print job is a print job which does not use the subscription service.

According to the present invention, it is possible to monitor for unauthorized private use of a subscription service while taking privacy into consideration.

Further features of the present invention will become apparent from the following description of exemplary embodiments (with reference to the attached drawings).

### BRIEF DESCRIPTION OF THE DRAWINGS

FIG. 1 is a diagram showing a configuration of a management system including an image forming apparatus according to the present embodiment.

FIG. 2 is a block diagram schematically showing a configuration of the image forming apparatus appearing in FIG. 1.

FIG. 3 is a block diagram schematically showing a configuration of a PC appearing in FIG. 1.

FIG. 4 is a sequence diagram showing a flow from a step in which a user inputs a print job to a step in which logs generated by execution of the print job are provided to a client.

FIG. 5 is a diagram showing an example of a print setting screen displayed on a display section when the user selects a personal use driver.

FIG. 6 is a diagram showing an example of a print setting screen displayed on the display section when the user selects a subscription service contract use driver.

FIG. 7 is a diagram showing an example of print data generated by the PC appearing in FIG. 1.

FIG. 8 is a diagram showing an example of a notification screen displayed on the display section.

FIG. 9 is a diagram showing an example of information managed by a subscription service management server appearing in FIG. 1.

FIG. 10 is a flowchart of a print process in a step in FIG. 4.

FIGS. 11A and 11B are diagrams useful in explaining storage of an image log, a job log, an operation log, and a debug log, acquired in a step in FIG. 10.

FIG. 12 is a diagram useful in explaining storage of consumables information acquired in a step in FIG. 10.

FIG. 13 is a flowchart of a log-and-consumables information transmission process in a step in FIG. 4.

FIG. 14 is a flowchart of a variation of the print process in the step in FIG. 4.

FIGS. 15A and 15B are diagrams useful in explaining storage of logs of print jobs and the consumables information in the present embodiment.

FIG. 16 is a flowchart of a variation of the log-and-consumables information transmission process in the step in FIG. 4.

FIG. 17 is a flowchart of another variation of the log-and-consumables information transmission process in the step in FIG. 4.

FIG. 18 is a sequence diagram showing a flow in a configuration in which the logs are directly transmitted from the image forming apparatus appearing in FIG. 1 to the PC operated by the client, from a step in which the user inputs a print job to a step in which the logs generated by execution of the print job are provided to the client.

FIG. 19 is a flowchart of a transmission control process in a step in FIG. 18.

FIG. 20 is a sequence diagram showing a flow in a configuration in which the logs and the consumables information are transmitted from the image forming apparatus appearing in FIG. 1 to the PC, from a step in which the user inputs a print job to a step in which the logs generated by execution of the print job are provided to the client.

FIG. 21 is a flowchart of a print process in a step in FIG. 20.

FIG. 22 is a flowchart of a log-and-consumables information transmission process in a step in FIG. 20.

### DESCRIPTION OF THE EMBODIMENTS

The present invention will now be described in detail below with reference to the accompanying drawings showing embodiments thereof.

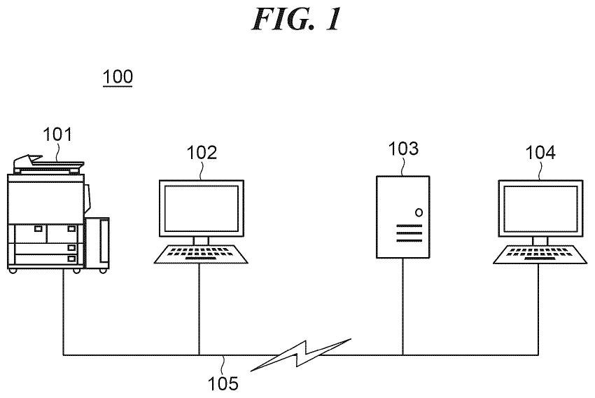

FIG. 1 is a diagram showing a configuration of a management system 100 including an image forming apparatus according to the present embodiment. Referring to FIG. 1, the management system 100 is formed by the image forming apparatus, denoted by reference numeral 101, a personal computer (PC) 102, a subscription service management server 103, and a PC 104. These apparatuses can communicate with each other via a network 105.

Let it be assumed that the image forming apparatus 101 and the PC 102 have been installed e.g. in a user's home. Further, let it be assumed that as for use of the image forming apparatus 101, a contract in one of plans A and B, described hereinafter, has been made between a company where the user works and a subscription service provider for the image forming apparatus.

The subscription service management server 103 is a server that provides the subscription service for the image forming apparatus and is managed by the subscription service provider. The subscription service management server 103 acquires logs generated when the image forming apparatus 101 executes a print job, and the like, from the image forming apparatus 101, and manages the acquired logs.

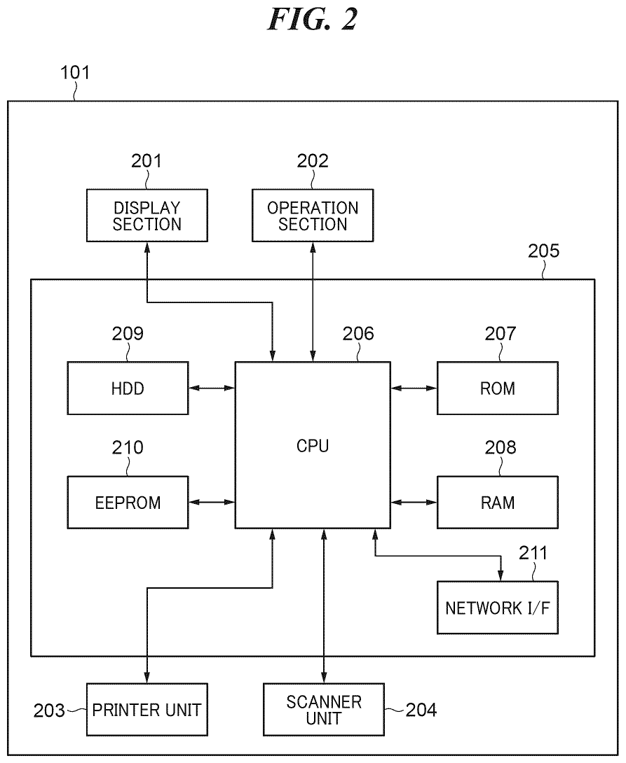

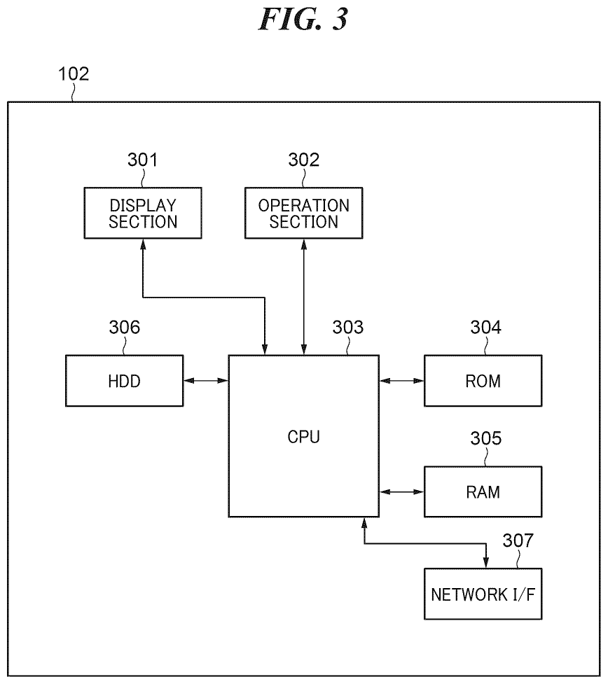

The user can cause the image forming apparatus 101 to execute a print job by operating an operation section 202, described hereinafter with reference to FIG. 2, of the image forming apparatus 101, or an operation section 302, described hereinafter with reference to FIG. 3, of the PC 102. In the present embodiment, in a case where a document of the company is printed, the user causes the image forming apparatus 101 to execute a print job by using the subscription service contracted by the company. On the other hand, in a case where the user performs private printing, the user causes the image forming apparatus 101 to execute a print job without using the subscription service. Thus, in the present embodiment, the user properly switches whether or not to use the subscription service according to the purpose of use.

A client as the contractor who has made the contract of the subscription service with the subscription service provider acquires logs of a print job from the subscription service management server 103 by operating the PC 104. The client monitors for unauthorized private use of the subscription service based on the acquired logs of the print job.

FIG. 2 is a block diagram schematically showing a configuration of the image forming apparatus 101 appearing in FIG. 1. Referring to FIG. 2, the image forming apparatus 101 includes a display section 201, the operation section 202, a printer unit 203, a scanner unit 204, and a controller unit 205. The display section 201, the operation section 202, the printer unit 203, and the scanner unit 204 are each connected to the controller unit 205.

The display section 201 includes an LED or a liquid crystal display and displays contents of an operation performed by the user and information on the image forming apparatus 101. The operation section 202 includes a plurality of operation buttons and receives a variety of operations from the user. Further, the operation section 202 can not only include the plurality of operation buttons but also form a touch display in combination with the display section 201.

The printer unit 203 receives a print instruction from the controller unit 205 and prints image data transmitted from the controller unit 205 on a sheet. Further, the printer unit 203 switches a printing speed according to a printing speed instruction notified from the controller unit 205 when the image forming apparatus 101 is started. The scanner unit 204 performs an operation of reading an original according to a reading instruction received from the controller unit 205 to generate image data of the original and transmits the generated image data to the controller unit 205.

The controller unit 205 is formed by a central processing unit (CPU) 206, a read-only memory (ROM) 207, a random-access memory (RAM) 208, a hard disk drive (HDD) 209, an electrically erasable programmable read-only memory (EEPROM) 210, and a network interface 211. The CPU 206 controls operations of the components connected to the controller unit 205 by executing control programs loaded from the ROM 207 or the HDD 209 into the RAM 208. The ROM 207 stores a boot program necessary for starting the system, and the like. The RAM 208 is a volatile memory and is a work memory used e.g. when a control program is executed. The HDD 209 is a storage medium, such as a magnetic disk, and stores control programs, image data, and so forth. The EEPROM 210 is a nonvolatile memory and stores settings necessary for execution of a control program. Further, the EEPROM 210 stores a serial number for identifying the image forming apparatus 101, a printing speed to be notified to the printer unit 203, a counter value indicating the number of prints produced, the contract information of the subscription service, and so forth. The network interface 211 is an interface for connection to the network 105 to perform data communication with an external apparatus.

FIG. 3 is a block diagram schematically showing a configuration of the PC 102 appearing in FIG. 1. Referring to FIG. 3, the PC 102 includes a display section 301, the operation section 302, a CPU 303, a ROM 304, a RAM 305, an HDD 306, and a network interface 307.

The display section 301 includes an LED or a liquid crystal display and displays contents of an operation performed by the user and information on the PC 102. The operation section 302 is formed by a mouse and a keyboard, and receives a variety of operations from the user.

The CPU 303 controls operations of the components of the PC 102 by executing control programs loaded from the ROM 304 or the HDD 306 into the RAM 305. The ROM 304 is a read-only memory and stores e.g. a boot program necessary for starting the system. The RAM 305 is a volatile memory and is a work memory used when a control program is executed. The HDD 306 is a storage medium, such as a magnetic disk, and stores control programs, image data, and so forth. The control program is, for example, a control program for a print driver as a software module for causing the image forming apparatus 101 to execute a print job from the PC 102. Note that in the PC 102, two print drivers, i.e. a subscription service contract use driver and a personal use driver have been installed. The user selects a print driver to be used from these two print drivers according to the purpose of use. Specifically, in a case where the user performs printing of a document of the company, the subscription service contract use driver is selected, whereas in a case where the user performs private printing, the personal use driver is selected. The network interface 307 is an interface for connecting to the network 105 to perform data communication with an external apparatus.

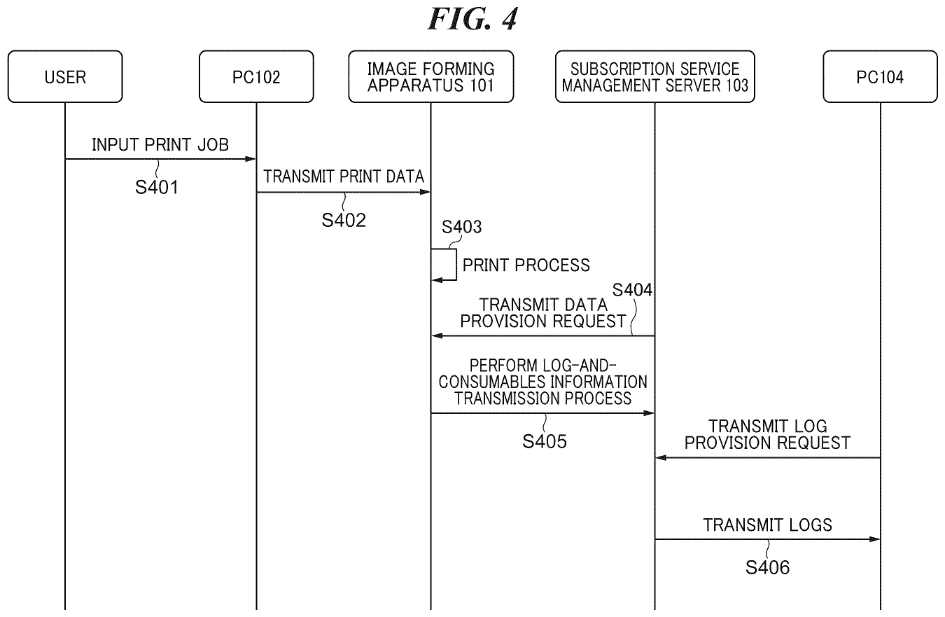

FIG. 4 is a sequence diagram showing a flow from a step in which the user inputs a print job to a step in which logs generated by execution of the print job are provided to the client.

Referring to FIG. 4, first, the user inputs a print job by operating the operation section 302 of the PC 102 (S401). At this time, the user selects a print driver for generating print data so as to cause the image forming apparatus 101 to execute the print job, from the subscription service contract use driver and the personal use driver, on a setting screen (not shown) displayed on the display section 301.

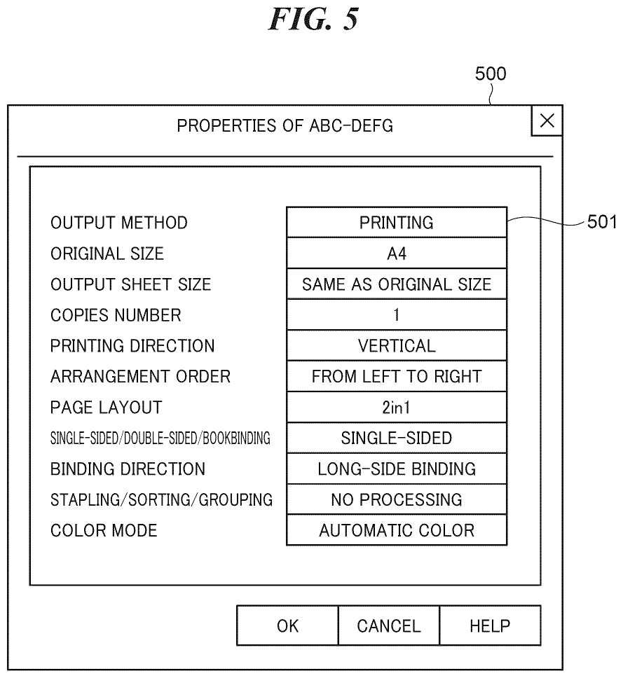

For example, in a case where the user selects the personal use driver on the setting screen, a print setting screen 500 shown in FIG. 5 is displayed on the display section 301. On the print setting screen 500, a variety of settings used when printing is performed are set. For example, when print data is received, the user sets, as an output method 501, one of “printing” for immediately starting printing of the print data and “reservation printing” for holding the print data without immediately starting printing of the print data when print data is received.

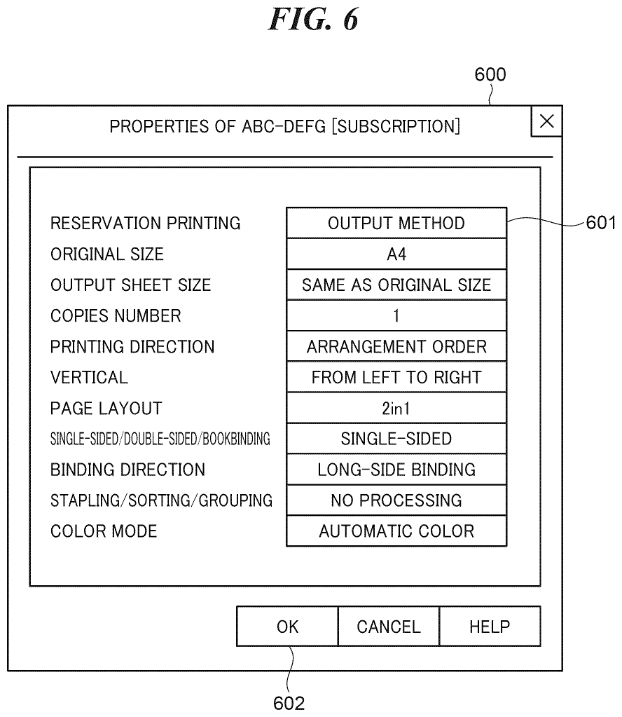

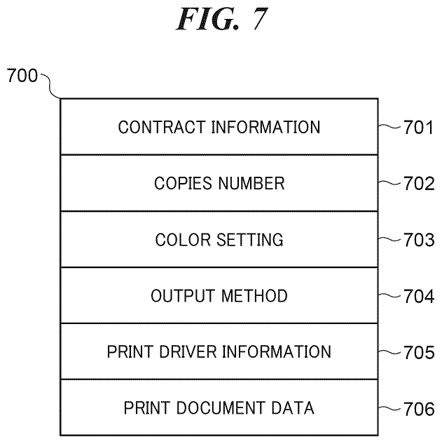

On the other hand, in a case where the user selects the subscription service contract use driver on the setting screen, a print setting screen 600 shown in FIG. 6 is displayed on the display section 301. On the print setting screen 600, a variety of settings used when printing is performed are also set. Note that the print setting screen 600 displays a notification indicating a state in which the subscription service is being used, differently from the print setting screen 500. Further, on the print setting screen 600, differently from the print setting screen 500, a setting which can be selected as an output method 601 is only “reservation printing”. For example, when the user sets the variety of settings and selects an OK button 602 on the print setting screen 600, the PC 102 generates print data 700 shown in FIG. 7 using the subscription service contract use driver.

The print data 700 includes contract information 701, a copies number (number of copies) 702, a color setting 703, an output method 704, print driver information 705, and print document data 706. The contract information 701 is information on a plan of the subscription service contracted by the company, and the like. The copies number 702 is a setting of the number of copies designated on the print setting screen 600. The color setting 703 is a setting of a color mode designated on the print setting screen 600. The output method 704 is a setting designated in the output method 601 on the print setting screen 600. The print driver information 705 is information indicating a print driver selected by the user on the setting screen, i.e. the subscription service contract use driver. The print document data 706 is e.g. image data or data of Microsoft Word, designated by the user, as an object to be printed. Note that in a case where the user selects the personal use driver on the setting screen, for example, settings designated on the print setting screen 500 are set in the copies number 702, the color setting 703, and the output method 704, and information indicating the personal use driver is set in the print driver information 705.

Then, the PC 102 transmits the generated print data 700 to the image forming apparatus 101 (S402).

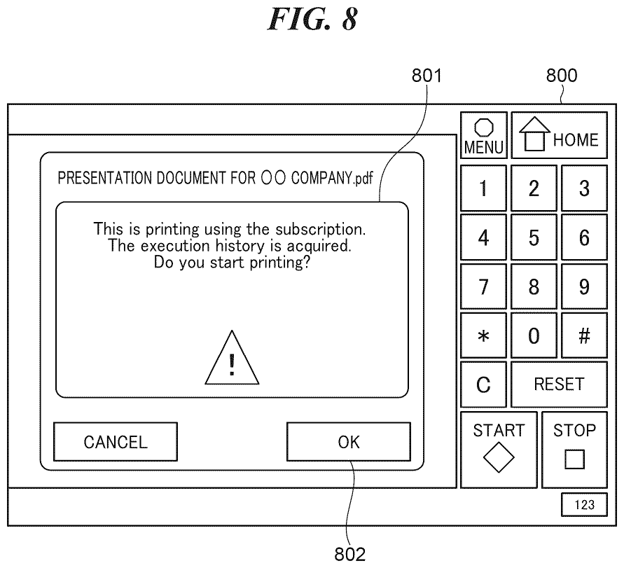

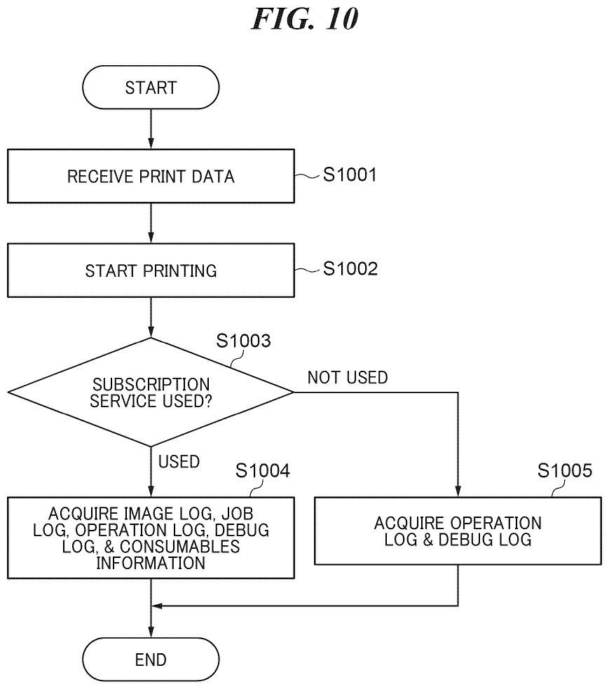

The image forming apparatus 101 having received the print data 700 displays a print data selection screen (not shown) for causing the user to select print data, on the display section 201. For example, in a case where the user selects the print data 700 generated by the subscription service contract use driver on the print data selection screen and provides an instruction for executing a print job based on the selected print data 700, a notification screen 800 shown in FIG. 8 is displayed on the display section 201. The notification screen 800 includes a warning notification 801 indicating execution of a print job using the subscription service. This makes it possible to provide the user with an opportunity to notice private use of the subscription service. When the user selects an OK button 802 on the notification screen 800, the image forming apparatus 101 performs a print process, described hereinafter with reference to FIG. 10 (S403).

When the image forming apparatus 101 performs the print process, described hereinafter, a plurality of logs are acquired, and further, consumables information, such as information on the number of prints and information on an amount of used ink, is acquired. The logs are stored in the HDD 209, and the consumables information is stored in the EEPROM 210.

After that, the subscription service management server 103 transmits a data provision request for instructing provision of the logs and the consumables information to the image forming apparatus 101 (S404). Note that the subscription service management server 103 transmits the data provision request not only to the image forming apparatus 101, but also to other image forming apparatuses managed by the subscription service management server 103.

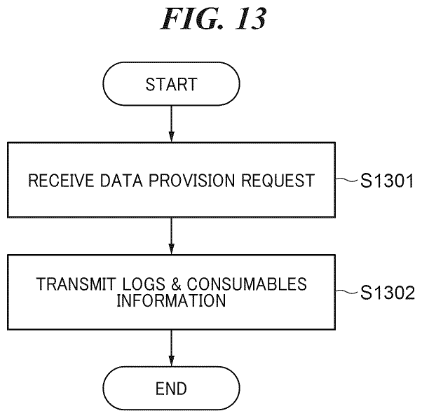

The image forming apparatus 101 performs control to provide the logs to the client. Specifically, the image forming apparatus 101 executes a log-and-consumables information transmission process, described hereinafter with reference to FIG. 13 (S405) to transmit the logs and the consumables information to the subscription service management server 103 in response to the received data provision request. The subscription service management server 103 manages the received logs and consumables information.

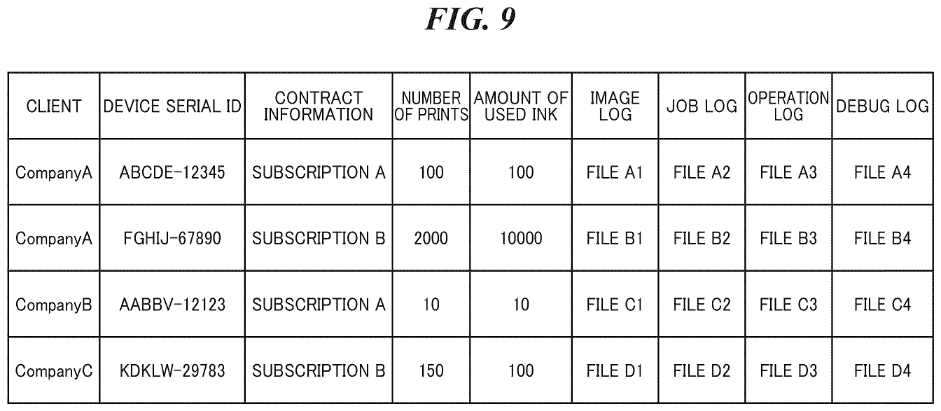

FIG. 9 is a diagram showing an example of the information managed by the subscription service management server 103 appearing in FIG. 1. For example, the subscription service management server 103 registers logs and consumables information, which are received from the image forming apparatus 101, in a state associated with identification information of each client and a device serial identifier (ID) of each image forming apparatus 101. The subscription service management server 103 periodically executes the processing in the step S404 with respect to all of the image forming apparatuses to be managed. Thus, the subscription service management server 103 manages the logs and the consumables information, which are received from each image forming apparatus, for each client.

Referring again to FIG. 4, when a request for providing the logs is received from the PC 104 operated by the client, the subscription service management server 103 transmits the logs associated with the client to the PC 104 (S406). This is the flow from the step in which the user inputs a job to the step in which the logs generated by execution of the job are provided to the client.

FIG. 10 is a flowchart of the print process in the step S403 in FIG. 4. The print process in FIG. 10 is realized by the CPU 206 executing a program stored in the HDD 209 or the like.

Referring to FIG. 10, upon receipt of the print data 700 from the PC 102 (S1001), the CPU 206 displays the print data selection screen on the display section 201. When the user provides an instruction for starting a print job based on the print data 700 selected on the print data selection screen, the CPU 206 starts printing based on the print data 700 (S1002). Note that in a case where not “reservation printing”, but “printing” is set in the received print data 700, printing based on the print data 700 is immediately started even when the instruction is not provided by the user. Then, the CPU 206 determines, based on the print driver information 705 included in the print data 700, whether or not the subscription service is used in the print job (S1003).

If it is determined in the step S1003 that the print driver information 705 indicates the subscription service contract use driver, it is determined that the print job is a print job using the subscription service, and the print process proceeds to a step S1004.

In the step S1004, the CPU 206 acquires an image log, a job log, an operation log, and a debug log, and further, acquires the consumables information. The image log is image information of the print document data 706. The job log is information on a user name of the user who has input the print job, a data name of the print document data 706, and so forth. The operation log is information on the operation history, such as a key operation and a BOX operation performed by the user. The debug log is a log output to look into, when an error occurs during execution of a print job, the cause of the error.

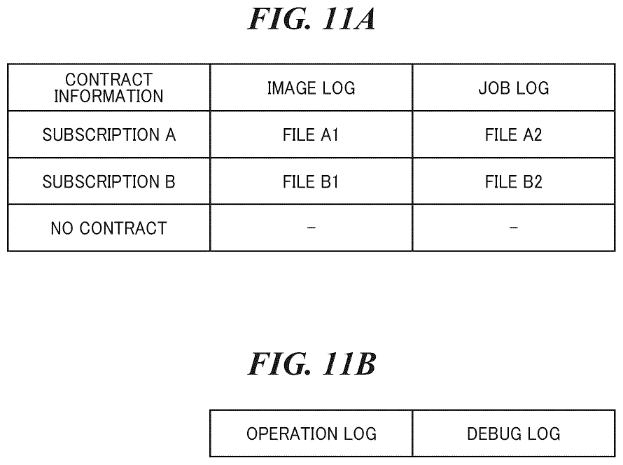

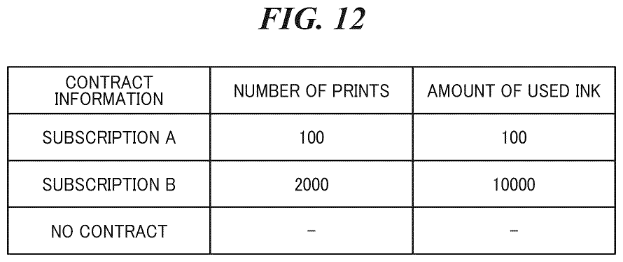

Then, the CPU 206 stores the acquired image log, job log, operation log, and debug log in the HDD 209 and stores the acquired consumables information in the EEPROM 210. Note that in the HDD 209, the image logs and the job logs are managed in a state sorted into files on a contract basis, as shown in FIG. 11A, and the operation logs and the debug logs are not managed on a contract basis, as shown in FIG. 11B. Further, in the EEPROM 210, the consumables information is separately managed on a contract basis, as shown in FIG. 12. After that, the print process is terminated.

If it is determined in the step S1003 that the print driver information included in the received print data indicates the personal use driver, it is determined that the print job is a print job which does not use the subscription service, and the print process proceeds to a step S1005.

In the step S1005, the CPU 206 acquires the operation log and the debug log. The CPU 206 stores the acquired operation log and debug log in the HDD 209. Here, the image log is the image information of the print document data 706 as mentioned above. Further, the job log is the information on the user name of the user who has input the print job, the data name of the print document data 706, and so forth. With these characteristics, information related to the privacy is included in the image log and the job log of a print job which does not use the subscription service. For this reason, in the present embodiment, the image log and the job log of a print job which does not use the subscription service are not stored in the HDD 209. When the processing in the step S1005 is completed, the print process is terminated.

FIG. 13 is a flowchart of the log-and-consumables information transmission process in the step S405 in FIG. 4. The log-and-consumables information transmission process in FIG. 13 is realized by the CPU 206 executing a program stored in the HDD 209 or the like.

Referring to FIG. 13, when the CPU 206 receives a data provision request from the subscription service management server 103 (S1301), the long-and-consumables information transmission process proceeds to a step S1302.

In the step S1302, the CPU 206 transmits the logs stored in the HDD 209 and the consumables information stored in the EEPROM 210 to the subscription service management server 103. Here, as described above, in the present embodiment, logs including information related to the privacy, specifically, the image log and the job log of each print job which does not use the subscription service are not stored in the HDD 209. Therefore, the image log and the job log of each print job which does not use the subscription service are prevented from being transmitted from the image forming apparatus 101 to the subscription service management server 103 and the PC 104 operated by the client. When the processing in the step S1302 is completed, the log-and-consumables information transmission process is terminated.

According to the above-described embodiment, the control to provide all logs of print jobs using the subscription service to the client is performed. Further, the predetermined control is performed to prevent leakage of the information related to the privacy from the logs of print jobs which do not use the subscription service. This makes it possible to monitor for unauthorized private use of the subscription service while taking the privacy into consideration.

Further, in the above-described embodiment, the predetermined control is control not to acquire an image log and a job log, including the information related to the privacy, out of the logs of a print job which does not use the subscription service. With this, it is possible to prevent leakage of the information related to the privacy from the logs of print jobs which do not use the subscription service.

Further, in the above-described embodiment, whether or not the subscription service is used in a print job is determined based on the print driver information 705 included in the print data 700. This makes it possible to easily perform the determination on whether or not the subscription service is used, which is necessary for monitoring for unauthorized private use of the subscription service, from the print data 700 used for printing.

Note that in the present embodiment, if it is determined in the step S1003 that the print job is a print job which does not use the subscription service, the job log, the operation log, and the debug log, which have been masked, can be stored in the HDD 209.

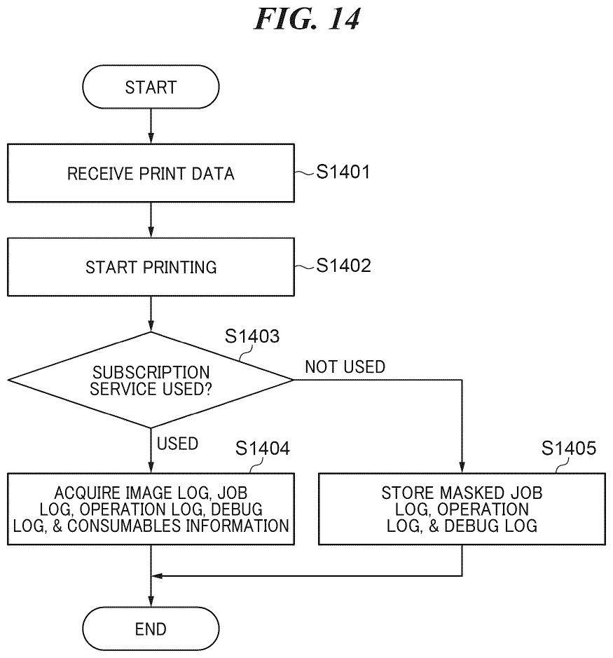

FIG. 14 is a flowchart of a variation of the print process performed by the image forming apparatus 101 appearing in FIG. 1. Note that the print process in FIG. 14 is a process similar to the above-described print process in FIG. 10, and the following description will be given mainly of different processing from the print process in FIG. 10. Similar to the above-described print process in FIG. 10, the print process in FIG. 14 is also realized by the CPU 206 executing a program stored in the HDD 209 or the like.

Referring to FIG. 14, in steps S1401 to S1404, the same processing operations are executed as in the steps S1001 to S1004.

If it is determined in the step S1403 that the print job is a print job which does not use the subscription service, the CPU 206 acquires logs other than the image log, out of the logs of the print job which does not use the subscription service. Specifically, the CPU 206 acquires the job log, the operation log, and the debug log. Then, the CPU 206 performs masking processing on the job log. Note that the masking processing is processing for replacing the information related to the privacy, such as a user ID, a user name, a job name, and a data name of print document data, included in the job log, with special characters, such as “*”, to thereby prevent these information items from being identified. Then, the CPU 206 stores the masked job log, operation log, and debug log in the HDD 209 (S1405), followed by terminating the present process.

In the above-described embodiment, the predetermined control is control to acquire logs other than an image log, of logs of a print job which does not use the subscription service and perform masking processing on the job log. This makes it possible to prevent leakage of the information related to the privacy from the job logs of the print job which does not use the subscription service.

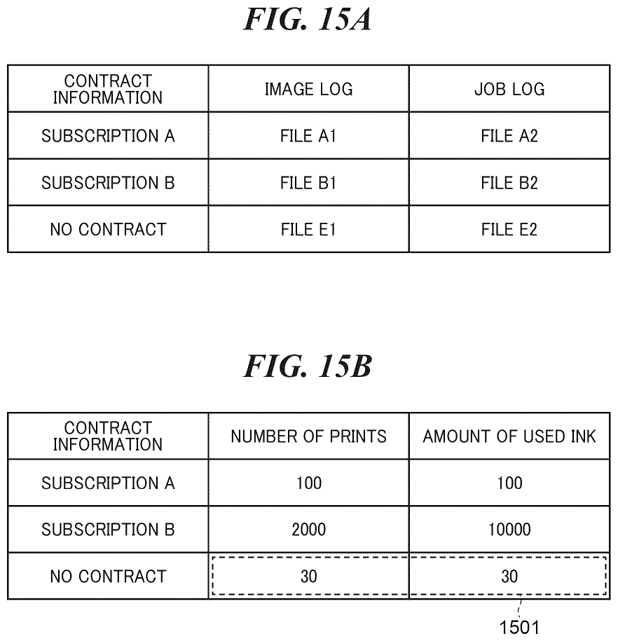

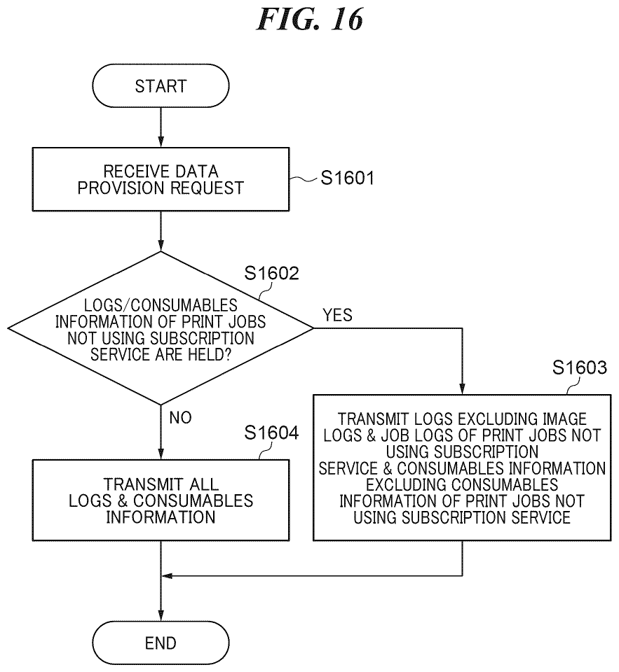

Further, in the present embodiment, when a data provision request is received from the subscription service management server 103, the image forming apparatus 101 can control what log is to be transmitted to the subscription service management server 103. In this configuration, in the print process, the image forming apparatus 101 executes the step S1004 after printing is started in the step S1002. That is, the image log, the job log, the operation log, and the debug log of the executed print job are stored in the HDD 209, and the consumables information is stored in the EEPROM 210 regardless of whether or not the subscription service is used. At this time, in the HDD 209, the image log and the job log of the print job which does not use the subscription service are managed in a state sorted into files as indicated e.g. by a file E1 and a file E2 in FIG. 15A. Further, in the EEPROM 210, as the consumables information of the print job which does not use the subscription service, the information on the number of prints and the information on the amount of used ink (see e.g. data 1501 in FIG. 15B) are stored in a state associated with the contract information “no contract”. After that, the image forming apparatus 101 executes a log-and-consumables information transmission process in FIG. 16.

FIG. 16 is a flowchart of a variation of the log-and-consumables information transmission process in the step S405 in FIG. 4. Note that the log-and-consumables information transmission process in FIG. 16 is a process similar to the above-described log-and-consumables information transmission process in FIG. 13, and the following description will be given mainly of different processing from the log-and-consumables information transmission process in FIG. 13. Similar to the above-described log-and-consumables information transmission process in FIG. 13, the log-and-consumables information transmission process in FIG. 16 is also realized by the CPU 206 executing a program stored in the HDD 209 or the like.

Referring to FIG. 16, first, a step S1601 which is the same processing as the step S1301 is executed. Then, the CPU 206 determines whether or not the image forming apparatus 101 holds logs or consumables information of print jobs which do not use the subscription service (S1602). For example, in a case where the file E1 and the file E2 in FIG. 15A are stored in the HDD 209, it is determined that the image forming apparatus 101 holds logs or consumables information of a print job which does not use the subscription service. Further, in a case where the data 1501 in FIG. 15B is stored in the EEPROM 210, it is also determined that the image forming apparatus 101 holds logs or consumables information of a print job which does not use the subscription service. In these cases, the log-and-consumables information transmission process proceeds to a step S1603.

In the step S1603, the CPU 206 transmits the logs of each print job which does not use the subscription service except the image logs and the job logs to the subscription service management server 103 from the plurality of logs stored in the HDD 209. Here, a case will be described by way of example, where the operation log and the debug log are stored in the HDD 209, as shown in FIG. 11B, and the image log and the job log are stored in the HDD 209, as shown in FIG. 15A. The logs excluding the file E1 corresponding to the image log of the print job which does not use the subscription service and the file E2 corresponding to the job log of this print job from these logs are transmitted. Thus, in the present embodiment, the image log and the job log including the information related to the privacy, out of the logs of the print job which does not use the subscription service, are prevented from being transmitted to the outside.

Further, in the step S1603, the CPU 206 transmits the consumables information excluding the consumables information of the print job which does not use the subscription service from the plurality of consumables information stored in the EEPROM 210 to the subscription service management server 103. Here, a case will be described, by way of example, where the consumables information is stored in the EEPROM 210 as shown in FIG. 15B. Thus, the consumables information excluding the data 1501 as the consumables information of the print job which does not use the subscription service from the consumables information stored in the EEPROM 210 is transmitted. After that, the log-and-consumables information transmission process is terminated.

If it is determined in the step S1602 that the image forming apparatus 101 does not hold a log or consumables information of a print job which does not use the subscription service, the log-and-consumables information transmission process proceeds to a step S1604. In the step S1604, the CPU 206 transmits all logs stored in the HDD 209 and all consumables information stored in the EEPROM 210 to the subscription service management server 103. After that, the log-and-consumables information transmission process is terminated.

In the above-described embodiment, the predetermined control is control not to transmit image logs and job logs including the information related to the privacy, out of the logs of print jobs which do not use the subscription service, to the outside. This makes it possible to prevent leakage of the information related to the privacy from the logs of print jobs which do not use the subscription service.

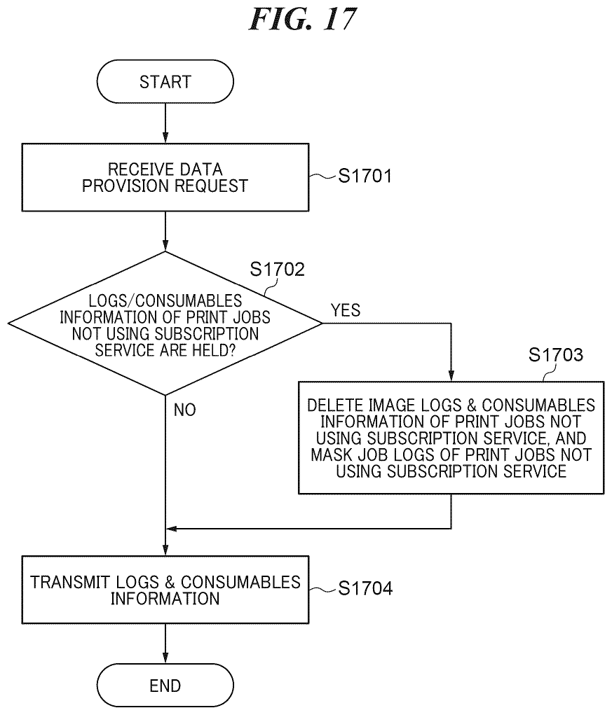

Further, in the present embodiment, when a data provision request is received from the subscription service management server 103, the image forming apparatus 101 can perform control to perform masking processing on job logs of print jobs which do not use the subscription service. In this configuration, in the print process, the image forming apparatus 101 executes the step S1004 after printing is started in the step S1002. That is, the image log, the job log, the operation log, and the debug log of the executed print job are stored in the HDD 209, and the consumables information is stored in the EEPROM 210 regardless of whether or not the subscription service is used. At this time, in the HDD 209, the image log and the job log of the print job which does not use the subscription service are managed in a state sorted into files as indicated e.g. by the file E1 and the file E2 in FIG. 15A. Further, in the EEPROM 210, as the consumables information of the print job which does not use the subscription service, the information on the number of prints and the information on an amount of used ink (see e.g. the data 1501 in FIG. 15B) are stored in a state associated with the contract information “no contract”. After that, the image forming apparatus 101 executes a log-and-consumables information transmission process in FIG. 17.

FIG. 17 is a flowchart of another variation of the log-and-consumables information transmission process performed by the image forming apparatus 101 appearing in FIG. 1. Note that the log-and-consumables information transmission process in FIG. 17 is a process similar to the above-described log-and-consumables information transmission processes in FIGS. 13 and 16, and the following description will be given mainly of different processing from the above-described log-and-consumables information transmission processes in FIGS. 13 and 16. Similar to the above-described log-and-consumables information transmission processes in FIGS. 13 and 16, the log-and-consumables information transmission process in FIG. 17 is also realized by the CPU 206 executing a program stored in the HDD 209 or the like.

Referring to FIG. 17, a step S1701 which is the same processing as the step S1301 is executed, and then, a step S1702 which is the same processing as the above-described step S1602 is executed.

If it is determined in the step S1702 that the image forming apparatus 101 holds logs or consumables information of a print job which does not use the subscription service, the log-and-consumables information transmission process proceeds to a step S1703. In the step S1703, the CPU 206 deletes the image log, e.g. the file E1, of the print job which does not use the subscription service from the HDD 209. Further, in the step S1703, the CPU 206 deletes the consumables information, e.g. the data 1501, of the print job which does not use the subscription service from the EEPROM 210. Further, in the step S1703, the CPU 206 performs masking processing on the job log, e.g. the file E2, of the print job which does not use the subscription service.

Then, the CPU 206 transmits all logs stored in the HDD 209 and all consumables information stored in the EEPROM 210 to the subscription service management server 103 (S1704), followed by terminating the present process.

In the above-described embodiment, the predetermined control is control not to transmit, to the outside, an image log, out of logs acquired as the logs of print jobs which do not use the subscription service, and to transmit, to the outside, logs other than the image log and the job log, and the masked job log. This makes it possible to prevent leakage of the information related to the privacy from the job log of the print job which does not use the subscription service.

Further, in the present embodiment, there can be employed a configuration in which the logs are directly transmitted from the image forming apparatus 101 to the PC 104 operated by the client.

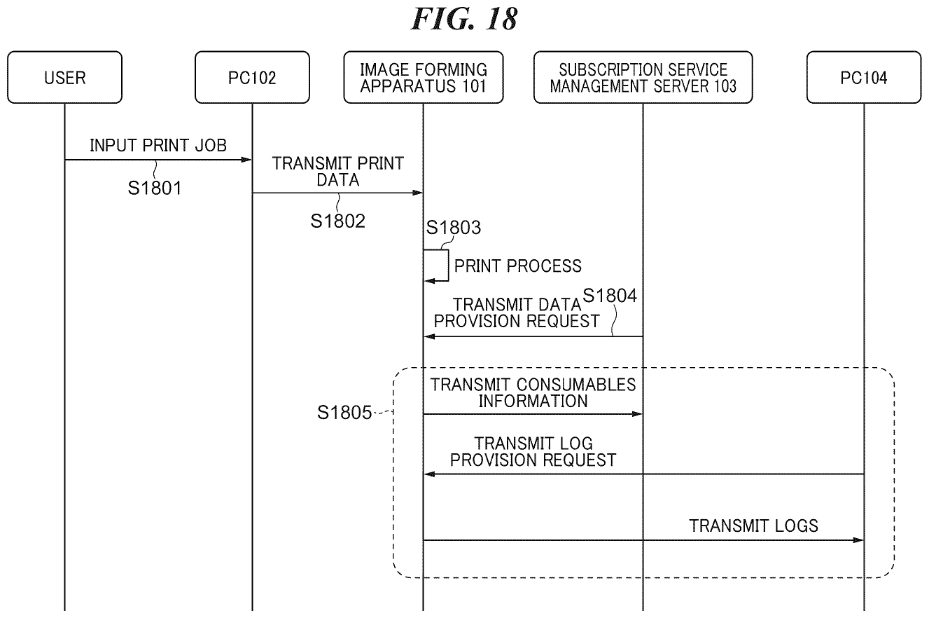

FIG. 18 is a sequence diagram showing a flow in the configuration in which the logs are directly transmitted from the image forming apparatus 101 appearing in FIG. 1 to the PC 104 operated by the client, from a step in which the user inputs a print job to a step in which the logs generated by execution of this print job are provided to the client. Note that the sequence shown in FIG. 18 is similar to the above-described sequence in FIG. 4, and the following description will be given mainly of different processing from the above-described sequence in FIG. 4.

Referring to FIG. 18, in steps S1801 to S1803, the same processing operations are executed as in the above-described steps S401 to S403. In the step S1803, the above-described print process in FIG. 10 or FIG. 14 is performed. Then, a step S1804 which is the same processing as the above-described step S404 is executed.

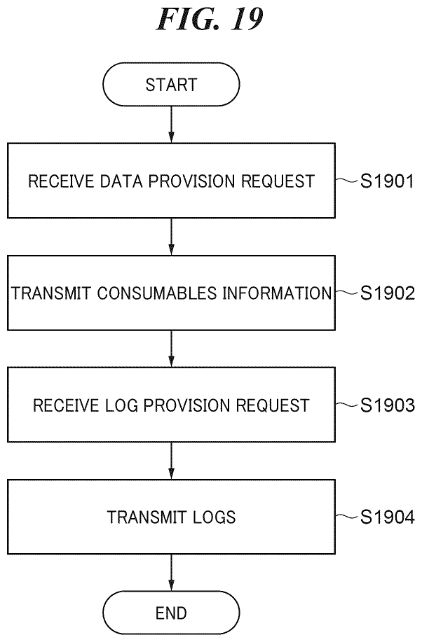

Then, the CPU 206 executes a transmission control process, described hereinafter with reference to FIG. 19 (S1805). In the step S1805, the CPU 206 transmits the consumables information stored in the EEPROM 210 to the subscription service management server 103. Further, in the step S1805, the CPU 206 transmits the logs stored in the HDD 209 to the PC 104 in response to a log provision request received from the PC 104 operated by the client. This is the flow from the step in which the user inputs a print job to the step in which the logs generated by execution of the print job are provided to the client.

FIG. 19 is a flowchart of the transmission control process in the step S1805 in FIG. 18. The transmission control process in FIG. 19 is realized by the CPU 206 executing a program stored in the HDD 209 or the like.

Referring to FIG. 19, first, when the CPU 206 receives a data provision request from the subscription service management server 103 (S1901), the transmission control process proceeds to a step S1902. In the step S1902, the CPU 206 transmits the consumables information stored in the EEPROM 210 to the subscription service management server 103. Note that the consumables information is consumables information of a print job using the subscription service as described above.

Then, when the CPU 206 receives a log provision request from the PC 104 operated by the client (S1903), the transmission control process proceeds to a step S1904. In the step S1904, the CPU 206 transmits the logs stored in the HDD 209 to the PC 104. Note that, for example, in a case where a print job using the subscription service is executed in the print process in the step S1803, the image log, the job log, the operation log, and the debug log are stored in the HDD209 as described above.

On the other hand, in a case where a print job which does not use the subscription service is executed in the print process in FIG. 10 in the step S1803, the operation log and the debug log, out of the logs of this print job, are stored in the HDD 209 as described above. Further, in a case where a print job which does not use the subscription service is executed in the print process in FIG. 14 in the step S1803, the operation log, the debug log, and the masked job log, out of the logs of the print job, are stored in the HDD 209 as described above. When the processing in the step S1904 is completed, the transmission control process is terminated.

Thus, in the configuration in which the logs are directly transmitted from the image forming apparatus 101 to the PC 104 operated by the client, it is also possible to monitor for unauthorized private use of the subscription service while taking the privacy into consideration.

Further, in the present embodiment, there can be employed a configuration in which the logs and the consumables information are transmitted from the image forming apparatus 101 to the PC 102.

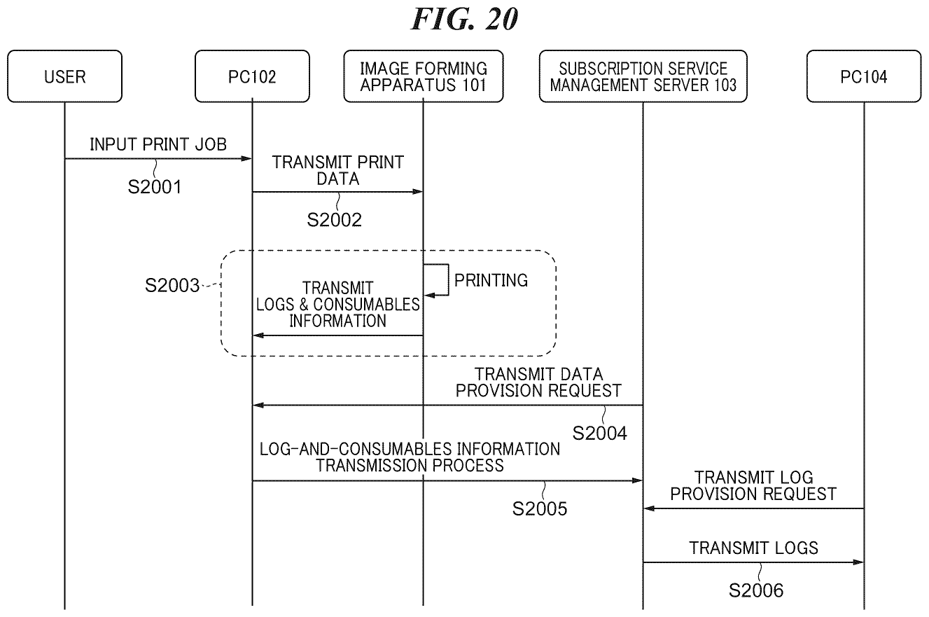

FIG. 20 is a sequence diagram showing a flow in the configuration in which the logs and the consumables information are transmitted from the image forming apparatus 101 appearing in FIG. 1 to the PC 102, from a step in which the user inputs a print job to a step in which the logs generated by execution of this print job are provided to the client. Note that the sequence shown in FIG. 20 is similar to the above-described sequence in FIG. 4, and the following description will be given mainly of different processing from the above-described sequence in FIG. 4. Note that in FIG. 20, the subscription service management server 103 has acquired the address information of the PC 102 managed by the client when the contract for the subscription service has been made.

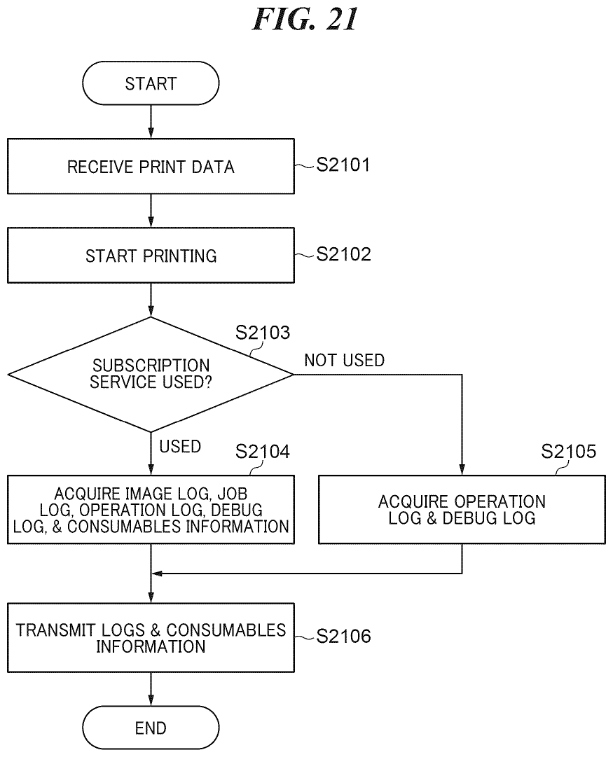

Referring to FIG. 20, first, in steps S2001 and S2002, the same processing operations are executed as in the above-described steps S401 and S402. Then, the image forming apparatus 101 executes a print process, described hereinafter with reference to FIG. 21 (S2003). In the step S2003, the image forming apparatus 101 performs printing based on the print data received from the PC 102, stores the logs generated by the printing in the HDD 209, and stores the consumables information generated by the printing in the EEPROM 210. Further, the image forming apparatus 101 transmits the logs stored in the HDD 209 and the consumables information stored in the EEPROM 210 to the PC 102.

After that, the subscription service management server 103 transmits a data provision request for instructing provision of the logs and the consumables information to the PC 102, based on the address information acquired when the contract for the subscription service was made (S2004).

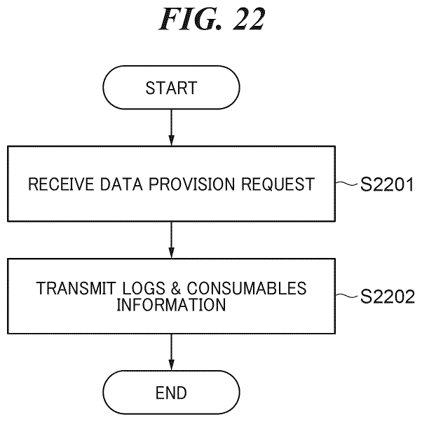

The PC 102 performs a log-and-consumables information transmission process, described hereinafter with reference to FIG. 22 (S2005), and transmits the logs and the consumables information of the image forming apparatus 101 to the subscription service management server 103 in response to the data provision request. The subscription service management server 103 manages the received logs and consumables information in the above-described state shown in FIG. 9.

Upon receipt of a log provision request from the PC 104 operated by the client, the subscription service management server 103 transmits the logs associated with this client to the PC 104 (S2006). This is the flow from the step in which the user inputs a print job to the step in which the logs generated by execution of this print job are provided to the client.

FIG. 21 is a flowchart of the print process in the step S2003 in FIG. 20. Note that the print process in FIG. 21 is a process similar to the above-described print process in FIG. 10, and the following description will be given mainly of different processing from the above-described print process in FIG. 10. Similar to the above-described print process in FIG. 10, the print process in FIG. 21 is also realized by the CPU 206 executing a program stored in the HDD 209 or the like.

Referring to FIG. 21, in steps S2101 to S2105, the same processing operations are executed as in the above-described step S1001 to S1005. Then, the CPU 206 transmits the logs stored in the HDD 209 and the consumables information stored in the EEPROM 210 to the PC 102 (S2106), followed by terminating the present process. Thus, in the present embodiment, whenever the image forming apparatus 101 executes a print job, the logs and the consumables information, acquired by execution of the print job, are transmitted to the PC 102. The PC 102 stores the logs and the consumables information, which are received from the image forming apparatus 101, in the HDD 306.

FIG. 22 is a flowchart of the log-and-consumables information transmission process in the step S2005 in FIG. 20. The log-and-consumables information transmission process in FIG. 22 is realized by the CPU 303 of the PC 102 executing a program stored in the HDD 306 or the like.

Referring to FIG. 22, when the CPU 303 receives a data provision request from the subscription service management server 103 (S2201), the log-and-consumables information transmission process proceeds to a step S2202.

In the step S2202, the CPU 303 transmits the logs and the consumables information, which are stored in the HDD 306, to the subscription service management server 103. Here, for example, in a case where a print job using the subscription service is executed in the print process in the step S2003, the image log, the job log, the operation log, and the debug log are stored in the HDD 306 as described above. On the other hand, in a case where a print job which does not use the subscription service is executed in the print process in the step S2003, the operation log and the debug log, out of the logs of the print job, are stored in the HDD 306 as described above. Therefore, the image log and the job log of the print job which does not use the subscription service are prevented from being transmitted from the PC 102 to the subscription service management server 103. When the step S2202 is completed, the log-and-consumables information transmission process is terminated.

Thus, in the present embodiment, even in an environment where the image forming apparatus 101 cannot directly communicate with the subscription service management server 103, it is possible to monitor for unauthorized private use of the subscription service while taking the privacy into consideration.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-128019 filed Aug. 4, 2023, which is hereby incorporated by reference herein in its entirety.

What is claimed is:

1. An image forming apparatus that executes a print job based on print data received from a communication apparatus, comprising:
at least one processor; and
a memory coupled to the at least one processor storing instructions that, when executed by the processor, cause the processor to function as:
a determination unit configured to determine whether or not a subscription service is used in the print job; and
a control unit configured to perform control to provide logs of the print job to a contractor of the subscription service,
wherein in a case where the print job is a print job using the subscription service, the control unit performs control to provide all logs of the print job to the contractor of the subscription service, whereas in a case where the print job is a print job which does not use the subscription service, the control unit performs predetermined control to prevent leakage of information related to privacy from logs of the print job.

2. The image forming apparatus according to claim 1, wherein the control unit performs control to provide logs acquired when the print job has been executed to the contractor of the subscription service, and
wherein the predetermined control is control not to acquire logs including the information related to the privacy, out of logs of the print job which does not use the subscription service.

3. The image forming apparatus according to claim 1, further comprising a storage unit, and
wherein the logs of the print job at least include an image log including image information of print document data forming the received print data, and a job log including a user name of a user who has instructed execution of the print job and a data name of the print document data,
wherein the predetermined control is control to acquire logs other than the image log, out of logs of the print job which does not use the subscription service, store the acquired logs in the storage unit, and perform masking processing on the job log stored in the storage unit, and
wherein the control unit performs control to provide the logs stored in the storage unit to the contractor of the subscription service.

4. The image forming apparatus according to claim 1, wherein the predetermined control is control not to transmit a log including the information related to the privacy, out of the logs of the print job which does not use the subscription service, to the outside.

5. The image forming apparatus according to claim 1, wherein the logs of the print job at least include an image log including image information of print document data forming the received print data, a job log including a user name of a user who has instructed execution of the print job and a data name of the print document data, and other logs, and
wherein the predetermined control is control not to transmit the image log to the outside and to transmit the other logs and the job log subjected to masking processing to the outside, out of logs acquired as the logs of the print job which does not use the subscription service.

6. The image forming apparatus according to claim 1, further comprising a reservation printing function for holding, when print data is received, the print data without immediately printing the print data, and
a display unit configured to display, in response to receipt of an instruction for executing a print job which is based on the held print data and uses the subscription service, a warning notification indicating execution of a print job using the subscription service.

7. The image forming apparatus according to claim 1, wherein the determination unit determines, based on information which is included in the print data and indicates a print driver used for generating the print data, whether or not the subscription service is used in a print job based on the print data.

8. A method of controlling an image forming apparatus that executes a print job based on print data received from a communication apparatus, comprising:
determining whether or not a subscription service is used in the print job; and
performing control to provide logs of the print job to a contractor of the subscription service, and
wherein the control includes control to provide all logs of the print job to the contractor of the subscription service in a case where the print job is a print job using the subscription service, and predetermined control to prevent leakage of information related to privacy from logs of the print job in a case where the print job is a print job which does not use the subscription service.

9. A non-transitory computer-readable storage medium storing a program for causing a computer to execute a method of controlling an image forming apparatus that executes a print job based on print data received from a communication apparatus,
wherein the method comprises:
determining whether or not a subscription service is used in the print job; and
performing control to provide logs of the print job to a contractor of the subscription service, and
wherein the control includes control to provide all logs of the print job to the contractor of the subscription service in a case where the print job is a print job using the subscription service, and predetermined control to prevent leakage of information related to privacy from logs of the print job in a case where the print job is a print job which does not use the subscription service.
